(19) United States
(12) Patent Application Publication
(10) Pub. No.: US 2026/0311195 A1
(43) Pub. Date: Oct. 8, 2026

(54) METHOD FOR CARRYING OUT A TRANSACTION RELATING TO AT LEAST ONE NON-FUNGIBLE TOKEN UNIQUELY ASSOCIATED WITH A PHYSICAL PRODUCT

(71) Applicant: AURA BLOCKCHAIN CONSORTIUM, Genève (CH)

(72) Inventors: David DE ABREU, Jassans Riottier (FR); Sébastien TAUPIN, Chatou (FR)

(73) Assignee: AURA BLOCKCHAIN CONSORTIUM, Genève (CH)

(21) Appl. No.: 19/482,835

(22) PCT Filed: May 7, 2024
(86) PCT No.: PCT/EP2024/062565

§ 371 Date: Nov. 10, 2025

(30) Foreign Application Priority Data
May 12, 2023 (FR) FR2304745

(51) Int. Cl. G06Q 30/018; G06Q 20/06; G06Q 20/36; G06Q 40/04

(52) U.S. Cl. CPC G06Q 30/0185; G06Q 20/065; G06Q 20/36; G06Q 40/055; G06Q 2220/00

(57) ABSTRACT

A method for carrying out a transaction in a blockchain-type database, relating to at least one non-fungible token, the method being wherein it includes carrying out steps of: (c) receiving, via a first client device of a first user that is the recipient of the transaction, a request to authenticate a physical product uniquely associated with the non-fungible token; (d) if the physical product is authenticated on the first client device, executing the transaction in the blockchain-type database.

### GENERAL TECHNICAL FIELD

The present invention relates to the field of transaction security. More specifically, it concerns a method for carrying out a transaction in a blockchain-type database and a method for carrying out a transaction relating to a product.

### PRIOR ART

Products from major luxury brands (such as handbags, jewelry, watches, etc.) often have a value that decreases only slightly over time due to their rarity, and in some cases even increases. Thus, these products are highly sought after on the resale market, known as the secondary market.

The problem is that this secondary market is plagued by the increasing presence of illegal or counterfeit products, which malicious third parties hope to sell alongside legitimate products, especially since transactions are most often conducted privately, without involving a professional who would be able to assess the product.

To solve this problem, solutions for the unique identification (and therefore authentication) of a product have been proposed:
Some products incorporate a physical element such as an RFID tag or a QR code, encoding a unique identifier of the product;
So-called “fingerprinting” solutions are also known, enabling the creation of a unique and unforgeable digital identity of a product from a photo, in particular from visible micro-defects;
More recently, specifically trained artificial intelligence algorithms make it possible to recognize each copy of a product.

These solutions are satisfactory and allow a potential purchaser to ensure that the product they are about to purchase is original and not a copy, but they do not make it possible to ensure that it has not been stolen.

Luxury products are sold with a certificate that actually aims to guarantee legal ownership of the product, but these certificates are themselves forgeable, and conversely, the seller may not be able to find their certificate.

The present invention improves this situation.

### PRESENTATION OF THE INVENTION

The present invention therefore relates, according to a first aspect, to a method for carrying out a transaction in a blockchain-type database, relating to at least one non-fungible token, the method being characterized in that it comprises carrying out steps of:
(c) Receiving, by a first client device of a first user that is the recipient of the transaction, a request to authenticate a physical product uniquely associated with said non-fungible token;
(d) If said physical product is authenticated on said first client device, executing said transaction in the blockchain-type database.

According to advantageous and non-limiting features:

The method comprises carrying out a step (b) of receiving, by a second client device of a second user that is the originator of the transaction, another request to authenticate the physical product uniquely associated with said non-fungible token.

Either step (c) is carried out if said physical product is authenticated on said second client device, or in step (d) said transaction is executed if said physical product is authenticated on each of the first and second client devices.

Step (c) comprises the verification of said authentication by an authority entity.

Step (d) comprises the payment of a gas fee.

The authentication of said physical product comprises at least one of: reading a QR code on the physical product, reading an electronic tag on the physical product, extracting a digital fingerprint from a photo of said physical product, and recognizing said physical product by an artificial intelligence algorithm.

Said blockchain-type database is the Ethereum® blockchain or one of its sidechains, and said non-fungible token is based on the ERC-721 standard.

The method is implemented in the form of a smart contract.

Said smart contract is controlled by a trusted third party, step (d) comprising the calculation and payment of a royalty for the benefit of said trusted third party, in particular in accordance with the ERC-2981 standard.

The non-fungible token contains metadata describing a history of said physical product, step (d) comprising updating said metadata.

According to a second aspect, the invention concerns a method for carrying out a transaction relating to the transfer of a physical product from a second user to a first user, characterized in that it comprises carrying out a step (a) of requesting, from a second client device of the second user, to transfer from the second user to the first user at least one non-fungible token uniquely associated with said physical product, and then carrying out the method according to the first aspect, wherein said transaction in a blockchain-type database is a transfer of said non-fungible token from the second user to the first user.

According to a third aspect, the invention concerns a method for carrying out a transaction relating to the initial acquisition by a first user of a physical product, characterized in that it comprises carrying out a step (a′) of requesting to create at least one non-fungible token uniquely associated with said physical product for the benefit of the first user, and then carrying out the method according to the first aspect, wherein said transaction in a blockchain-type database is the creation of said non-fungible token for the benefit of the first user.

According to a fourth aspect, the invention concerns a method for carrying out a transaction relating to the repair of a physical product of a first user comprising the replacement of at least one part of the product, characterized in that it comprises carrying out a step (a′) of requesting to create a new non-fungible token uniquely associated with said part of the physical product for the benefit of the first user, and then carrying out the method according to the first aspect, wherein said transaction in a blockchain-type database is the creation of said non-fungible token for the benefit of the first user.

According to advantageous and non-limiting features, a former non-fungible token is uniquely associated with said at least one part of the physical product prior to said repair, the method comprising carrying out a preliminary step (a″) of requesting to destroy said former non-fungible token uniquely associated with said part of the physical product.

According to a fifth aspect, the invention concerns a first client device of a first user that is the recipient of a transaction in a blockchain-type database, relating to a non-fungible token, characterized in that it is configured to:
receive a request to authenticate a physical product uniquely associated with said non-fungible token;
if said physical product is authenticated on said first client device, execute said transaction in the blockchain-type database.

According to a sixth aspect, the invention concerns an assembly of a first client device according to the fifth aspect and a second client device of a second user that is the originator of said transaction and configured to receive another request to authenticate the physical product uniquely associated with said non-fungible token.

According to a seventh and an eighth aspect, the invention concerns a computer program product comprising code instructions for executing a method according to the first aspect for carrying out a transaction in a blockchain-type database, relating to a non-fungible token; and a storage medium readable by computer equipment on which is recorded a computer program product comprising code instructions for executing a method according to the first aspect for carrying out a transaction in a blockchain-type database, relating to a non-fungible token.

### PRESENTATION OF THE FIGURES

Other features and advantages of the present invention will become apparent on reading the following description of a preferred embodiment. This description will be given with reference to the appended drawings in which:

FIG. 1 is a diagram of a system for carrying out the method according to the invention;

FIG. 2a is a diagram illustrating the transfer of a physical NFT of the prior art;

FIG. 2b is a diagram illustrating the transfer of a PBT in accordance with the invention;

FIG. 3a is a flowchart illustrating the steps of a first embodiment of the method according to the invention:

FIG. 3b is a flowchart illustrating the steps of a second embodiment of the method according to the invention;

FIG. 3c is a flowchart illustrating the steps of a third embodiment of the method according to the invention;

FIG. 3d is a flowchart illustrating the steps of a third embodiment of the method according to the invention.

### DETAILED DESCRIPTION

### Architecture

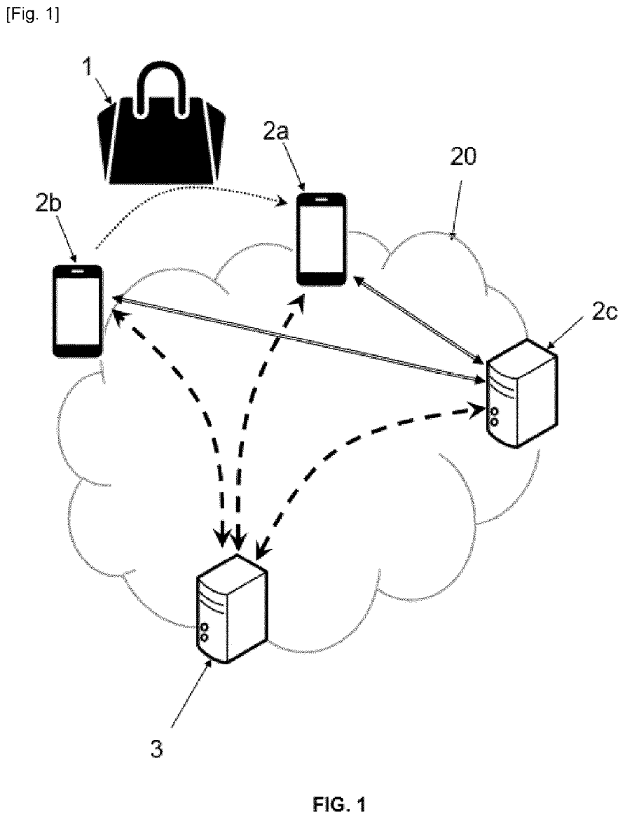

The present invention concerns a method for carrying out a transaction in a blockchain-type database 3 relating to a non-fungible token, which, as will be seen, will be uniquely associated with a physical product 1 (or a part of the product), in a system as shown in FIG. 1, in particular for carrying out a transaction relating to said product 1. This physical product can be any marketable commodity, in particular a luxury product such as a handbag, a watch, a pair of shoes, etc. Preferably, said physical product 1 is authenticatable, or even uniquely identifiable; techniques for this purpose will be presented later.

Said system comprises at least one client device 2a, 2b (generally a large number of them), advantageously acting as a “wallet,” each being a personal device of a user allowing them to perform transactions on their behalf, for example sending or receiving cryptocurrencies. As such, each client device 2a, 2b may implement an application such as MetaMask.

Alternatively, the wallets of each user may be managed in a decentralized manner, in particular by a third client device 2c of an authority entity such as the manufacturer of the product 1 (the brand), or a trusted third party (see below), connected to the devices 2a, 2b. Said optional third client device 2c is typically a remote and automated server, or a terminal of an employee of the brand. In particular, the third client device 2c can create and manage the wallets on behalf of the clients.

Still alternatively, instead of individual wallets, a single shared wallet, advantageously directly held by said authority entity (and therefore typically managed by the third device 2c), can be provided.

In all cases, there is in particular at least one first client device 2a, known as the creditor, as the device of a first “purchaser” user in said transaction (recipient of the transaction), and advantageously a second client device 2b, known as the debtor, as the device of a second “seller” user in said transaction (originator of the transaction). Said non-fungible token and/or said physical product are, in other words, transferred from the second user (of the second client device 2b) to the first user (of the first client device 2a). Note that a specific use case will be seen for the creation of the non-fungible token for the benefit of the first user (of the first client device 2a) and a case of destruction of the non-fungible token.

In the present case, each client device 2a, 2b is preferably a lightweight physical device such as a smart card or a terminal such as a smartphone, in particular a Secure Element of such a terminal, that is to say a dedicated, closed, enclave-type microprocessor. It will be understood that the present invention is not limited to these cases and that the client device 2a, 2b may still be a smartphone, a touch tablet, a personal computer, etc. Each client device 2a, 2b may further comprise a camera and/or an NFC or RFID reader.

Devices 2a, 2b, 2c communicate with each other via at least one network 20, for example the Internet network, a cellular network, or a combination of such networks. They each have read and write access to a blockchain-type database 3 stored in the network 20. It should be noted that in the same case there are also transaction validator devices, called “miners,” which are known to those skilled in the art and which will not be discussed in further detail.

The database 3 is public, in the sense that it is freely accessible for reading not only by the devices 2a, 2b, 2c present, but also by any other third-party device. Any third-party device can in particular consult the data written by one of the devices 2a, 2b, 2c.

“Blockchain”-type databases are generally used as the basis for electronic currency transaction systems. Each client device 2a, 2b, 2c stores a public key and a private key that are mutually associated and unique to it (and make it possible to perform transactions on the blockchain-type database 3). The private key makes it possible to write signed data to the database; it is intended not to be communicated to third parties. The public key allows the device 2a, 2b, 2c (and any other holder of a database 3 access account) to verify that data present in the database 3 was written to it by the device 2a, 2b, 2c. Generally, the client device 2a, 2b, 2c is designated by an address which is typically a cryptographic fingerprint of its public key.

Database 3 is distributed or decentralized within the network 20, meaning that it is stored by a plurality of nodes in the network 20 with which the devices 2a, 2b, 2c can communicate.

A blockchain-type database is distributed among several storage nodes of a network. The storage nodes are configured to validate data written to the database by carrying out a consensus-finding method among the storage nodes. Such a method is, for example, the “proof of work” (POW) or the “proof of stake” (POS). The content of the database (a history of all past transactions performed between user accounts in the system) is thus protected against falsification despite its distributed nature.

The most famous blockchain-type databases are the Bitcoin® or Ethereum® blockchain, typically the latter in the context of the present invention, or any other compatible blockchain, that is to say based on the EVM (Ethereum Virtual Machine), the execution environment for Ethereum instructions (in a language such as Solidity). These are referred to as “sidechains”, such as Polygon or Avalanche.

By non-fungible token, or NFT, it should be understood a type of cryptographic token that is transferable on a blockchain, just like a cryptocurrency, but unique and therefore non-interchangeable, unlike the latter. The Ethereum blockchains (or sidechains), but also Solana or Cardano, are the most widely used for NFTs.

An NFT generally contains a reference to a digital object such as an image or a video, sometimes artistic, of which it constitutes a kind of certificate of authenticity, and sometimes metadata. It is claimed that an NFT could represent ownership of said digital object, but there is no real legal basis for this.

“Mint” refers to the action of creating an NFT, generally by means of a smart contract on the blockchain, for example in accordance with the ERC-721 standard on the Ethereum blockchain. In particular, an ERC-721 token has a parameter tokenId making it unique (as opposed to a fungible ERC-20 token which is a standard ETH, that is to say the native cryptocurrency of the Ethereum blockchain). Like any other transaction on the blockchain, mint involves the payment of a “gas fee” to reward the miners for the computing power they must use to execute the transactions.

Similarly, “burn” refers to the action of destroying an NFT, by the same means.

### Principle

The present invention proposes a new type of NFT, advantageously still based on the ERC-721 standard, which will be called a “product-bound token,” or PBT, which very cleverly makes it possible to guarantee the ownership and authenticity of a physical product during a transaction.

It should be noted that it is already known to associate an NFT with a physical product (referred to as a “physical NFT”), for example if the digital data to which it points constitutes a unique digital identifier of said physical product, for example that encoded by a QR code or an RFID tag on the physical product, as explained in the introduction.

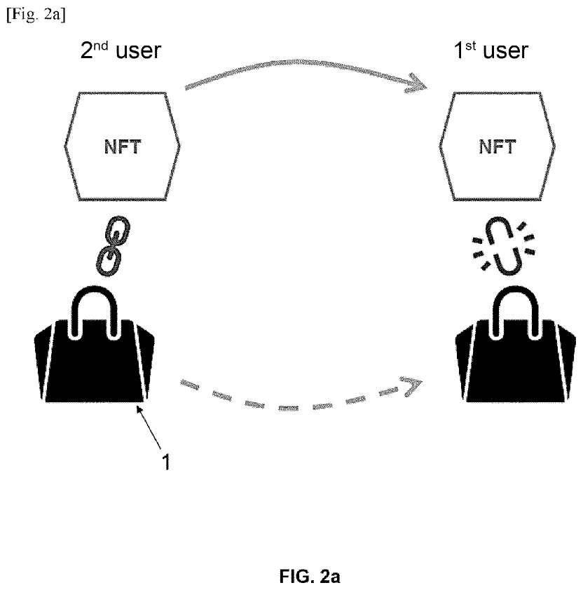

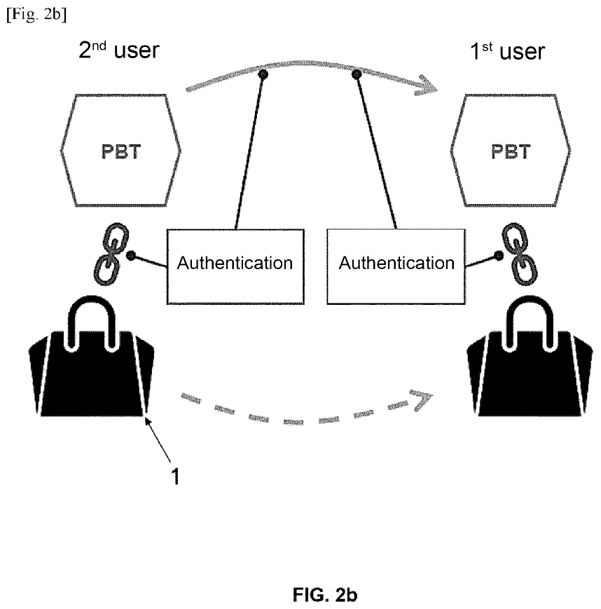

However, as can be seen in FIG. 2a, such physical NFTs do not provide any solution to the problem of reselling counterfeit or stolen products, and are only of advertising interest, since the NFT and the product can be resold independently. In practice, the valuable object is the physical NFT and the attached physical product is an “accessory” often offered with the purchase of the NFT.

On the contrary, the PBT is an NFT accessory to a physical product (and not the other way around), which in itself has no value and which is only transferable if the purchaser provides proof of ownership of the linked product, as can be seen in FIG. 2b. Thus:
If the product is counterfeit, the transfer of the NFT will be rejected;
If the product is stolen, it will not be resaleable due to lack of access to the NFT.

It should be noted that one or several non-fungible tokens according to the invention may be associated with the product, where appropriate with sub-parts of the product, that is to say parts, for example the shoulder strap of a bag, which will allow, where appropriate, repairs and their traceability (thus it will be possible to resell a product that has been repaired by guaranteeing that all the parts are original and that the product has been repaired in an official workshop). In any case, even when several tokens are associated with the same product, it will be understood that each token will always be uniquely associated with the product (it is impossible for a token to be associated with several products). Thus, in the following description, when referring to a token uniquely associated with a product, this means a token associated with the entire product and/or one of the tokens more specifically associated with a sub-part of the product.

It should be noted that it is even possible to combine a global token for the product (a “super token”) with tokens for the parts.

### Method for Carrying out a Transaction Relating to an NFT

As explained in a first aspect, the present invention concerns a method for carrying out a transaction in a blockchain-type database, relating to at least one non-fungible token, that is to say an NFT, here of the PBT type (and preferably each non-fungible token associated with the product 1).

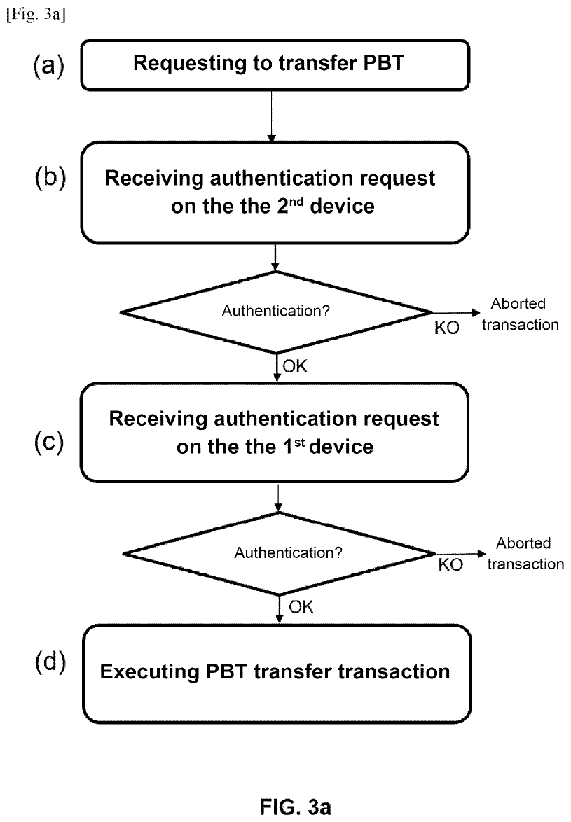

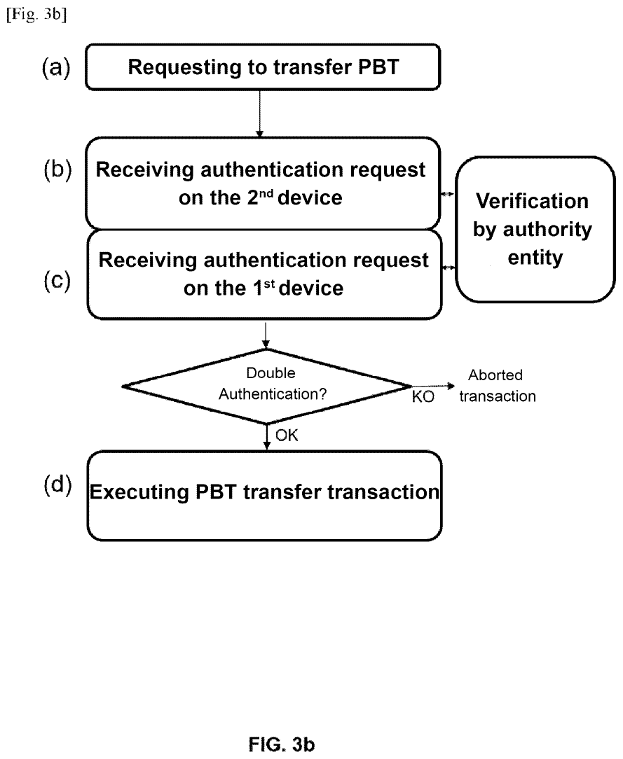

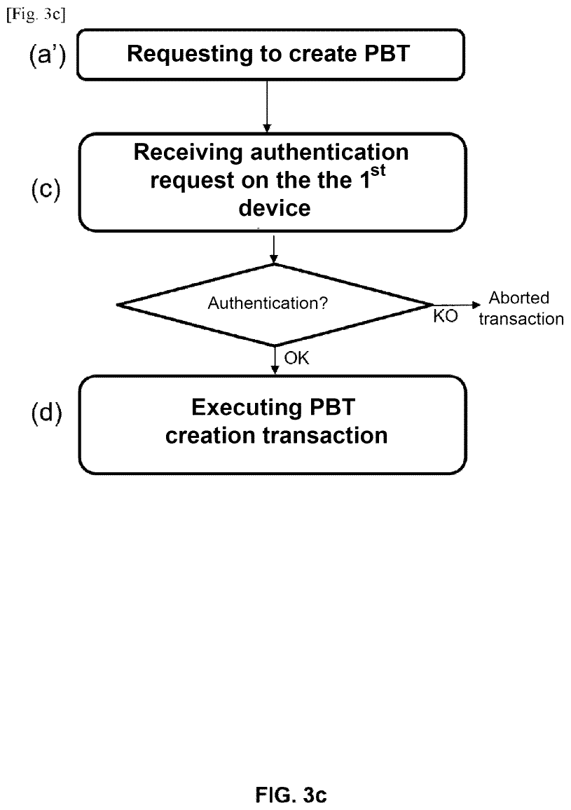

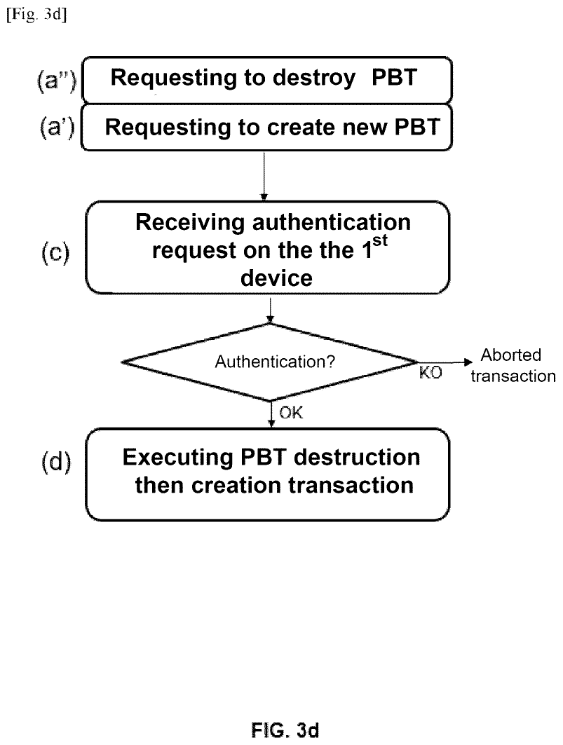

In practice, there are three possible types of transactions on said token:
Either a transfer of the token from the second user to the first user, preferably in the context of a transfer of the physical product 1 from the second user to the first user, represented by FIGS. 3a and 3b;
Or the creation of the token (“mint”) by the second user for the benefit of the first user, typically during the first sale of the physical product 1 or the repair of the product comprising the replacement of a part of the product, the token concerned being the new token of the replaced part (the second user is then the manufacturer of the product 1, that is to say the brand), represented by FIG. 3c;
Or the destruction of the token (“burn”) by the first user at the request of the second user, typically during the repair of the product comprising the replacement of a part of the product, the token concerned being the former token of the replaced part (the second user is then the manufacturer of the product 1, that is to say the brand), visible in FIG. 3d.

In the case of a transfer/initial sale of the product 1, all tokens associated with the product (including any super-token) are preferably transferred, and in the case of product repair, only the token(s) associated with the replaced part(s) are transferred.

If each user has their own wallet, the effect of the token transfer transaction is its movement from one wallet to another. In the case of a shared wallet held by an authority entity, the effect of this transaction is the modification of ownership information of the non-fungible token, in particular in the token's metadata. The transaction is therefore only an update of the token's metadata. In particular, each user can be designated by a client identifier, for example created at the user's first purchase.

The present methods are in all cases carried out by the data processing means of the client devices 2a and/or 2b and/or the optional 2c, typically in the form of a smart contract as permitted in particular by the Ethereum ecosystem, especially via an MTM (“multi-token minter”) centralizer which makes it possible to deploy smart contracts via any public blockchain. Alternatively, a trusted third party can be used, that is to say a dedicated platform such as OpenSea.

The methods include at least one step (c) of receiving, by the first client device 2a of the first user that is the recipient of the transaction, a request to authenticate the physical product 1 uniquely associated with said non-fungible token, and (d) executing said transaction in the blockchain-type database if said physical product 1 is authenticated on said first client device 2a.

By authentication of the physical product 1, it should be understood at least the verification of the authenticity of the physical product 1, and advantageously its identification, that is to say, verifying that it is indeed a specific copy of the product. In both cases, it is ensured that the first user has been given the original product and not a counterfeit.

Preferably, said authentication is a proximity authentication, involving the immediate presence of said physical product 1, and in particular a direct interaction of the first client device 2a with the product. This makes it possible to guarantee that the second user actually has the product 1 associated with the PBT in their possession, that is to say that the second user has, for example, handed it over in person or sent it by mail.

It should be noted that some authentication techniques that will be presented use a photo that is advantageously acquired directly by a camera of the first client device 2a, and not received from a remote terminal, which could lead to risks of falsification (it is understood in any case that the first user would have no interest in doing this since they are precisely trying to ensure that they have been given an authentic product).

Preferably, the authentication of said physical product 1 comprises at least one of:
reading a QR code on the physical product 1 (by a camera of the first client device 2a). In particular, a product identifier, or even a unique identifier of this copy of the product 1, can be extracted from the QR code, and this identifier can be verified, in particular by means of a proprietary function of the brand of said product, if applicable using digital data directly contained in or linked to the PBT. For example, a cryptographic fingerprint (hash) of a reference identifier of the product accessible via a URL contained in the PBT, known as the expected cryptographic fingerprint, can be provided (it could even be directly contained in the PBT), and the verification is performed by hashing (with a predefined hash function) the identifier extracted from the QR code and comparing it with said expected cryptographic fingerprint.
reading an electronic tag (also called a “radio tag”, typically NFC or RFID) on the physical product 1, for example by a suitable reader of the client device 2a. The same identification mechanism can be used as for the QR code;
extraction of a digital fingerprint from a photo of said physical product 1. Again, a reference digital fingerprint contained in or accessible via the PBT can be provided, and a mechanism can be used for calculating the distance between the extracted digital fingerprint and the expected fingerprint, in particular by fuzzy logic. Again, such a mechanism is known to those skilled in the art.
recognition of said physical product 1 by an artificial intelligence algorithm. Al algorithms such as classification neural networks (typically CNNs) can be directly provided by the product brands, taking as input a photo of the product 1 allowing them to directly answer the question of its authenticity, in a secure manner since it is a “black box”.

In the case where the transaction is a transfer or destruction of the PBT (FIGS. 3a, 3b and 3d), there is advantageously a preliminary step (b), similar to step (c), of receiving, by a second client device 2b of a second user that is the originator of the transaction, another request to authenticate a physical product 1 uniquely associated with said non-fungible token. Note that this is also the case in FIG. 2b. This makes it possible to ensure that in the case of a transfer, the second user (the seller) actually has an original, and therefore has the right to transfer the PBT, and in the case of a repair, that the first user entrusts the second user (the repairer) with an original, and therefore has the right to have a new PBT created for the replaced part-even if a counterfeit would obviously be detected in the workshop.

In the case where the transaction is a creation of the PBT for an initial acquisition (FIG. 3c), this other request to authenticate the physical product 1 by the second user is not essential, but it can be in particular carried out in advance, following manufacture (at the batch level). The result can be stored for authentication by the first user.

The same authentication/identification techniques for the product 1 are advantageously used.

In such a case of double authentication:
either step (c) is carried out if (and in particular only if) said physical product 1 is authenticated on said second client device 2b, as shown in FIG. 3a. In other words, at this stage the second user can transfer the physical product 1 to the first user, and this triggers the authentication request by the first user. This is an asymmetrical scheme, which is typically used if the product is transferred by mail or pre-authenticated, and therefore with a delay (and that represented by FIG. 3a if the transaction is a transfer). At step (d), it is then sufficient for the product 1 to be authenticated on the first client device 2a for the transaction to be executed.
or at step (d) said transaction is executed if (and in particular only if) said physical product 1 is authenticated on each of the first and second client devices 2a, 2b, as shown in FIG. 3b. In other words, the two authentications can be performed simultaneously or almost simultaneously, and we simply wait for the results of both verifications before starting the execution. This is a symmetrical scheme, which is typically used when the product 1 is handed over in person.

In any case, step (b) (if it occurs) and/or step (c) may comprise the verification of said authentication by an authority entity. By authority entity, it should be understood, as explained, either the manufacturer of the product 1 (the brand), or a trusted third party, for example an intermediary involved in the transaction, such as a marketplace.

The concept of verification of said authentication by an authority entity can be interpreted broadly here and can take many forms:
according to a first embodiment, a third, separate authentication can be performed, that is to say the presence of a step (c′) similar to steps (b) and/or (c) (which can occur anytime before step (d)) of receiving, by the optional third client device 2c of the authority entity (as explained, potentially a remote and automated server, or a terminal of an employee of the brand), another request to authenticate the physical product 1 uniquely associated with said non-fungible token. For example, each user can carry out an authentication via an electronic tag, and in addition, the authority entity can carry out remote authentication by recognizing said physical product 4 using a secret artificial intelligence algorithm: the second user performs their authentication (b) and takes a photo which they transfer to said third client device for performing it. Thus, when the first user receives the product 1, they know that it has also been authenticated by the brand, and they are even more convinced of the product's authenticity when they scan its electronic tag in step (c). Alternatively, the exchange can take place in a store, and the seller also authenticates the product 1.

In such an embodiment, again either step (b) or step (c) is carried out if said physical product 1 is authenticated on the third client device 2c of the authority entity (sequential operation), or in step (d) said transaction is executed if said physical product 1 is authenticated on each of the first and/or second client devices 2a, 2b, and the third client device 2c (triple authentication).
According to a second embodiment, visible in FIG. 3b, the first and/or second authentication is controlled by the authority entity, and it may be provided that, if necessary, the latter signs the transaction, and that only a signed transaction can be executed in step (d). This means that the authority entity certifies, for example, that a recognized authentication mechanism has been used, and correctly.
According to a third embodiment, the authority entity performs additional verifications making it possible to observe the context of the authentication, for example by analyzing the wear and tear of the product, comparing it with a digital maintenance log, verifying a warranty, but also verifying the location of the authentication if the transaction must take place at a specific location, etc.

Step (d) typically comprises the payment of a gas fee (by the first user, on their client device 2a, or possibly by the brand on the device 2c if this is included in the sale price). In other words, as soon as the required authentication(s) are completed, the transaction is executable, and it is the first user, who now has the assurance that the product is legally owned by the second user and was an original, who can trigger the actual transfer of the PBT by paying the gas fee or at least by instructing any third party managing their wallet to do so. The execution of the transaction in the blockchain is then done in a conventional manner: it is verified by the miners and included in the next mined block. The miners collect the gas fee for their work.

It should be noted that the transaction may also involve the transfer of cryptocurrencies from the first user to the second user as payment for the transfer of the PBT (and the physical product 1), particularly if each user has their own wallet, although, as will be seen, this transfer may involve a conventional payment outside the blockchain, or even be free of charge (a gift).

Step (d) may further comprise, particularly in the case of a cryptocurrency payment and when the smart contract is controlled by a trusted third party, the calculation and payment of a royalty to that trusted third party, as a commission for facilitating the transaction. This is typically permitted by the ERC-2981 standard.

Finally, and particularly preferably, the non-fungible token contains metadata describing a history of said physical product, known as traceability data. This may comprise the product's ownership history and/or repair and maintenance history, where applicable in a pseudo-anonymized manner. In this case, step (d) advantageously comprises updating said metadata, in particular by adding the transaction currently being performed. This allows for a complete, public, and unalterable record of what has happened to the product 1.

Preferably, this metadata constitutes a digital passport, or Digital Product Passport (DPP), of the product 1, compliant with the requirements of the European Commission.

### Method for Carrying Out a Transaction Relating to the Physical Product

Three methods for carrying out a transaction relating to the transfer of the physical product 1 will now be described, involving the method for carrying out a transaction in a blockchain-type database, relating to at least one non-fungible token, according to the first aspect.

According to a second aspect, said transaction relating to the transfer of the physical product 1 is from a second user to a first user; this is the case of resale of the physical product 1.

With reference to FIGS. 3a and 3b, the method begins with a step (a) of requesting, from the second client device 2b of the second user, to transfer the (and preferably each) non-fungible token uniquely associated with said physical product 1 (the PBT), from the second user to the first user.

It is understood that this step is only possible if the second user effectively has the PBT(s) in their wallet (or is clearly indicated as the owner in the shared wallet). Otherwise, it means that the product 1 has been stolen. This is performed in particular by identifying the first user on the second client device 2b, for example by providing a public address of their wallet in the case of an individual wallet, or a client identifier of the first user. If applicable, a first request is transmitted to the third client device 2c holding the wallet (to transfer the transaction information to it), and this device generates a second request, which is the request to execute the actual transaction (on the blockchain).

Then, the method according to the first aspect is carried out so as to carry out the transfer of said non-fungible token(s) from the second user to the first user as a transaction in a blockchain-type database that is the subject of the method (at least steps (c) and (d), and preferably step (b)). By step (c), the second user must have transmitted the physical product to the first user, if applicable against payment of a sum of money, in exchange for something, etc. Preferably, as explained, the transaction in the blockchain-type database 3 may involve the reverse transfer of electronic currency from the first user to the second user as payment. It may alternatively be a gift.

In summary, the method according to the second aspect is as follows:

Method for carrying out a transaction relating to the transfer of a physical product 1 from a second user to a first user, characterized in that it comprises carrying out steps of:
(a) requesting, from a second client device 2b of the second user, to transfer from the second user to the first user at least one (and preferably each) non-fungible token uniquely associated with said physical product 1,
(b) optionally, receiving by the second client device 2b, a request to authenticate the physical product 1;
(c) Receiving, by a first client device 2a of the first user, a request to authenticate the physical product 1:
(d) If said physical product 1 is authenticated on said first client device 2a (and, where applicable, on the second client device 2b), executing a transaction in the blockchain-type database to transfer said non-fungible token from the second user to the first user.

According to a third aspect, said transaction relating to the transfer of the physical product 1 is the initial acquisition by a first user of a physical product, such as a purchase in a store or online of a new physical product 1.

Referring to FIG. 3c, the method begins with a step (a′) of requesting to create at least one non-fungible token uniquely associated with said physical product 1 (the PBT), for the benefit of the first user, in particular either a single token associated with the product as a whole, or one token per part of the product. There may or may not be a second user, depending on whether this is done uniquely, or by a seller in a store on their client device (which is then the second client device 2b, which is then potentially identical to the optional third client device 2c of the authority entity—or there may again be a first and then a second request as in step (a)). This step may be triggered by the payment of the price of the new physical product 1.

If it is the first purchase of the first user, and in the case of a decentralized wallet, step (a′) may comprise the creation of their wallet on the third client device 2c. In the case of a shared wallet, a client identifier can simply be created for them.

Then, the method according to the first aspect is carried out again so as to carry out said creation (“mint”) of said non-fungible token(s) for the benefit of the first user as a transaction in a blockchain-type database that is the object of the method (at least steps (c) and (d)).

In summary, the method according to the third aspect is as follows:

Method for carrying out a transaction relating to the initial acquisition by a first user of a physical product 1, characterized in that it comprises carrying out steps of:
(a′) requesting to create at least one non-fungible token uniquely associated with said physical product 1 for the benefit of the first user;
(b) optionally, receiving by an optional second client device 2b from which the creation request would have been issued, a request to authenticate the physical product 1;
(c) Receiving, by a first client device 2a of the first user, a request to authenticate the physical product 1;
(d) If said physical product 1 is authenticated on said first client device 2a (and, where applicable, on the second client device 2b), executing a transaction in the blockchain-type database for the creation of said non-fungible token for the benefit of the first user.

According to a fourth aspect, said transaction relating to the transfer of the physical product 1 is the repair of a physical product 1 of a first user, typically in an official store. It is assumed that this repair comprises the replacement of one (or more) part(s) of the product, and that various parts of the product, including the part to be replaced, are each associated with a non-fungible token. It is understood that a worn version of said worn part is replaced by the same but new part.

The idea is that here we will simply create a new token for each part that has been replaced since it is now new, similarly to what is done in the method according to the third aspect.

Thus, as explained, the method begins with a step (a′) of requesting to create the non-fungible token uniquely associated with said replaced part, for the benefit of the first user, as described just before. This step can be triggered by the payment of the repair price, particularly when the product 1 is deposited.

Then, the method according to the first aspect is carried out again so as to carry out said creation (“mint”) of the non-fungible token for the benefit of the first user as a transaction in a blockchain-type database that is the subject of the method (at least steps (c) and (d)).

It should be noted that it may be desirable to first verify that the first user does indeed own the product 1. To do this, it is sufficient to provide for the destruction (“burn”) of the non-fungible token previously associated with the replaced part. By doing so, the former token of the part is replaced by the new one.

Thus, preferably, with reference to FIG. 3d, the method comprises a preliminary step (a″) of requesting to destroy the former non-fungible token uniquely associated with said part of the physical product 1 (and preferably each token associated with a part to be replaced). Step (a″) is carried out under the same conditions as step (a), except that the PBT is destroyed instead of being transferred.

The tokens associated with the other parts (not replaced) are not affected. In other words, only the tokens of the replaced parts are destroyed and then recreated.

It is understood that this step (a″) can be carried out only if the first user actually has the relevant PBTs(s) in their wallet (or is clearly indicated as the owner in the shared wallet). Otherwise, it means that the product 1 has been stolen. This step is performed in particular from the first terminal 2a if it is the one storing the first user's personal wallet.

Preferably, in the case of a centralized or shared wallet, steps (a″) and (a′) are carried out in the form of a joint request from the third client device 2c, itself under the instruction of the first or second device 2a, 2b. This makes it possible to link the destruction of the former token and the creation of the new one, so as to prevent a token from being destroyed without creating a new one (which would make the product unsaleable) or a new token from being created without destroying the former one (which would allow for fraud).

Step (c) (and therefore step (d)) can only be carried out upon recovery of the product after repair, which allows the user to ensure that an original part has indeed been installed on their product during the repair.

In summary, the method according to the fourth aspect is as follows:

Method for carrying out a transaction relating to the repair of a physical product 1 of a first user, comprising the replacement of at least one part of the product, characterized in that it comprises carrying out of the following steps:
(a″) Optionally, requesting to destroy a former non-fungible token uniquely associated with said part of the physical product 1;
(a′) requesting to create at least one new non-fungible token uniquely associated with said part of the physical product 1 for the benefit of the first user;
(b) optionally, receiving by the second client device 2b, a request to authenticate the physical product 1;
(c) Receiving, by a first client device 2a of the first user, a request to authenticate the physical product 1;
(d) If said physical product 1 is authenticated on said first client device 2a (and, where applicable, on the second client device 2b), executing a transaction in the blockchain-type database for the destruction of the former non-fungible token and then the creation of said new non-fungible token for the benefit of the first user.

### Client Devices

According to a fifth and/or a sixth aspect, the invention concerns the first and/or the second client device 2a, 2b, and in particular the assembly of the first and second client devices 2a, 2b, for carrying out the method for carrying out a transaction in a blockchain-type database, relating to a non-fungible token, according to the first aspect.

The first client device 2a, of a first user that is the recipient of a transaction in a blockchain-type database, relating to a non-fungible token, is configured to:
receive a request to authenticate a physical product 1 uniquely associated with said non-fungible token;
If said physical product 1 is authenticated on said first device client 2a, execute said transaction in the blockchain-type database.

The first client device 2b, of a second user that is the originator of said transaction in a blockchain-type database, relating to a non-fungible token, is configured to:
If said transaction is a transfer of a non-fungible token uniquely associated with said physical product 1, from the second user to the first user, require this non-fungible token transfer; or if the transaction is the creation of said non-fungible token uniquely associated with said physical product 1, for the benefit of the first user, require this creation of the non-fungible token;
receive any other request to authenticate the physical product 1 uniquely associated with said non-fungible token.

### Computer Program Product

According to a seventh and an eighth aspect, the invention concerns a computer program product comprising code instructions for executing (on the data processing means of the client devices 2a, 2b and/or 2c) a method according to the first aspect for carrying out a transaction in a blockchain-type database, relating to a non-fungible token (see also the methods according to the second or third aspect), as well as storage medium readable by computer equipment (for example the memories of the client devices 2a, 2b and/or 2c) on which this computer program product is found.

1. A method for carrying out a transaction in a blockchain-type database, relating to at least one non-fungible token, the method being wherein it comprises carrying out steps of:
(c) receiving, by a first client device of a first user that is the recipient of the transaction, a request to authenticate a physical product uniquely associated with said non-fungible token;
(d) if the physical product is authenticated on said first client device, executing said transaction in the blockchain-type database.

2. The method according to claim 1, comprising the step (b) of receiving, by a second client devices of a second user that is the originator of the transaction, another request to authenticate the physical product uniquely associated with said non-fungible token.

3. The method according to claim 2, wherein either step (c) is carried out if said physical product is authenticated on said second client device, or in step (d) said transaction is executed if said physical product is authenticated on each of the first and second client devices.

4. The method according to claim 1, wherein step (c) comprises the verification of said authentication by an authority entity.

5. The method according to claim 1, wherein step (d) comprises the payment of a gas fee.

6. The method according to claim 1, wherein the authentication of the physical product comprises at least one of: reading a QR code on the physical product, reading an electronic tag on the physical product, extracting a digital fingerprint from a photo of said physical product, and recognizing the physical product by an artificial intelligence algorithm.

7. The method according to claim 1, wherein said blockchain-type database is the Ethereum® blockchain or one of its sidechains, and said non-fungible token is based on the ERC-721 standard.

8. The method according to claim 1, implemented in the form of a smart contract.

9. The method according to claim 8, wherein the smart contract is controlled by a trusted third party, step (d) comprising the calculation and payment of a royalty for the benefit of said trusted third party, in particular in accordance with the ERC-2981 standard.

10. The method according to claim 1, wherein the non-fungible token contains metadata describing a history of said the physical product, step (d) comprising updating said metadata.

11. A method for carrying out a transaction relating to the transfer of a physical product from a second user to a first user, wherein it comprises carrying out a step (a) of requesting, from a second client device of the second user, to transfer from the second user to the first user at least one non-fungible token uniquely associated with said physical product, and then carrying out the method according to claim 1, wherein said transaction in a blockchain-type database is a transfer of said non-fungible token from the second user to the first user.

12. A method for carrying out a transaction relating to the initial acquisition by a first user of a physical product, wherein it comprises carrying out a step (a′) of requesting to create at least one non-fungible token uniquely associated with said physical product for the benefit of the first user, and then carrying out the method according to claim 1, in which the transaction in a blockchain-type database is the creation of said non-fungible token for the benefit of the first user.

13. A method for carrying out a transaction relating to the repair of a physical product of a first user, comprising the replacement of at least one part of the product, wherein it comprises carrying out a step of (a′) of requesting to create a new non-fungible token uniquely associated with the part of the physical product for the benefit of the first user, and then carrying out the method according to claim 1, in which the transaction in a blockchain-type database is the creation of the non-fungible token for the benefit of the first user.

14. The method according to claim 13, wherein a former non-fungible token is uniquely associated with the at least one part of the physical product prior to the repair, the method comprising carrying out a preliminary step of requesting to destroy the former non-fungible token uniquely associated with said part of the physical product.

15. A first client device of a first user that is the recipient of a transaction in a blockchain-type database, relating to at least one non-fungible token, wherein it is configured to:
receive a request to authenticate a physical product uniquely associated with said non-fungible token;
if the physical product is authenticated on said first client device, execute the transaction in the blockchain-type database.

16. An assembly of a first client device according to claim 15 and a second client device of a second user that is the originator of the transaction and configured to receive another request to authenticate the physical product uniquely associated with the non-fungible token.

17. A computer program product comprising code instructions for executing a method according to claim 1 for carrying out a transaction in a blockchain-type database, relating to at least one non-fungible token, when the program is executed on a computer.

18. A storage medium readable by computer equipment on which is recorded a computer program product comprising code instructions for executing a method according to claim 1 for carrying out a transaction in a blockchain-type database, relating to at least one non-fungible token.
